(19) United States
(12) Patent Application Publication
(10) Pub. No.: US 2008/0062943 A1
(43) Pub. Date: Mar. 13, 2008

(54) System and method for providing continuous AAA functionality in a IP-based mobile communication network

(76) Inventor: Jeou-Kai Lin, Campbell, CA (US)

Correspondence Address: FORTUNE LAW GROUP LLP, 100 CENTURY CENTER COURT, SUITE 315, SAN JOSE, CA, 95112, US

(21) Appl. No.: 11/518,299

(22) Filed: Sep. 9, 2006

(51) Int. Cl. H04B 7/216

(52) U.S. Cl. 370/342

(57) ABSTRACT

A system and method for providing continuous AAA functionality in an IP-based mobile communication network is disclosed. The system includes an RTP proxy coupled between clients in a session, the RTP proxy operable to (a) detect the handoff procedure and (b) notify a AAA server with updated client information. The method includes the steps of providing an RTP proxy coupled between clients in a session, detecting a handoff procedure, and notifying a AAA server with updated client information.

### BACKGROUND OF THE INVENTION

The present invention generally relates to mobile communications and more particularly to a system and method for providing continuous authentication, authorization and accounting (AAA) functionality in an IP-based mobile communication system.

In wireless communication systems, whether IP based (WiFi and WiMAX), or cellular based, mobility and continuity of service are ensured by handover or handoff procedures. A handoff procedure transfer's control of a mobile device from a first access point or base station to a second access point or base station when the mobile device moves out of range of the first access point or base station. The handoff procedure may determine not only which of a plurality of second access points or base stations to transfer control to, but also the timing of such transfer.

During a handoff procedure, one client may move from one subnet or domain to another. In this case, AAA functions cannot be effectively and continuously maintained for real time peer to peer communications unless each client is using an implementation specifying a proprietary Virtual Private Network (VPN). However, given the current proliferation of networks and different implementations, it is not likely that the clients are using the same proprietary VPN.

Communications in IP-based mobile communication systems are usually based on the Real Time Protocol (RTP). The association between a set of participants communicating using RTP is called an RTP session. A specific RTP session is identified by a particular pair of destination IP addresses together with a pair of ports.

AAA functions generally authorize the usage of a particular RTP session. If session information changes due to a new IP address or a new domain being assigned to one of the clients participating in the session after a handoff procedure, the authentication may fail and the communication not be authorized. Likewise, the accounting information based upon the RTP session may be inaccurate due to the new IP address or the new domain and lead to surcharges or undercharges resulting from miscalculations.

There is therefore a need in the art for a system and method for providing continuous AAA functionality in an IP-based mobile communication system that overcomes these problems in the prior art. There is also a need for a system and method that is not application specific. There is a further need for a system and method that is not AAA protocol specific. There is also a need for a system and method that is not client or network device specific.

### SUMMARY OF THE INVENTION

In accordance with the invention, an RTP proxy is assigned to behave as a AAA mobile agent during an RTP session. The RTP proxy relays real time communication between two real time endpoints to the AAA server and detects handoff procedures during the RTP session.

In accordance with one aspect of the invention, a system for providing continuous AAA functionality in a mobile communication network includes an RTP proxy coupled between clients in a session, the RTP proxy operable to (a) detect the handoff procedure and (b) notify a AAA server with updated client information.

In accordance with another aspect of the invention, a method for providing continuous AAA functionality in a mobile communication network includes the steps of providing an RTP proxy coupled between clients in a session. detecting a handoff procedure, and notifying a AAA server with updated client information.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

These and other features, aspects and advantages of the present invention will become better understood with reference to the following drawings, description and claims.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a schematic representation showing a first phase of an RTP session in accordance with the invention;

FIG. 2 is a schematic representation showing a second phase of the RTP session in accordance with the invention;

FIG. 3 is a schematic representation showing a third phase of an RTP session in accordance with the invention; and

FIG. 4 is a schematic representation showing a fourth phase of an RTP session in accordance with the invention.

### DETAILED DESCRIPTION OF THE INVENTION

The present invention provides a system and method for providing AAA functions in an IP-based mobile communication system. An RTP proxy is assigned to behave as a AAA mobile agent during an RTP session. The RTP proxy relays real time communication between two real time endpoints to the AAA server and detects handoff procedures during the RTP session

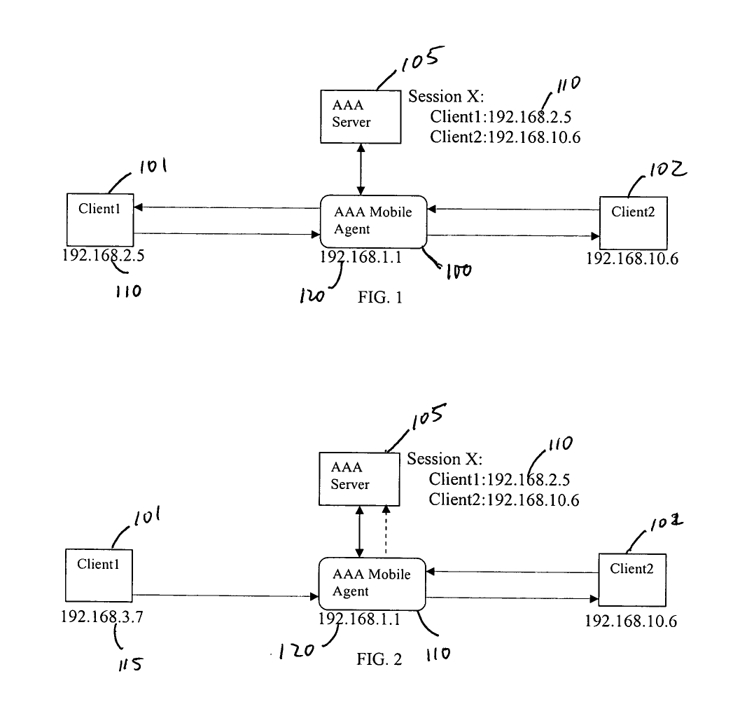

With reference to FIG. 1, an RTP session is represented between client 101 and client 102. AAA mobile agent 100 acts as an intermediary between client 101 and client 102. Clients 101 and 102 communicate with each other through the AAA mobile agent 100. The AAA mobile agent 100 is coupled to a AAA server 105.

After a handoff procedure, client 101 may move to a subnet having a different IP address. For example, client 101 may move from subnet 110 having the IP address 192.168.2.5 to the subnet 115 having the IP address 192.168.3.7 as shown in FIG. 2. The MA mobile agent 100 detects the handoff procedure and communicates the change of IP address to the AAA server 105.

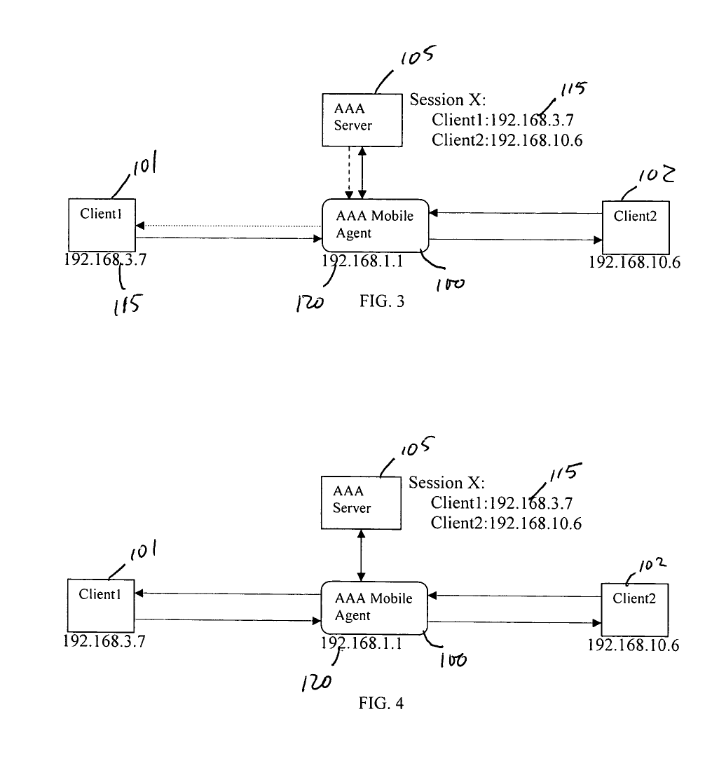

With reference to FIG. 3, the MA server 105 will update the RTP session with the new IP address 115. An authorization server module in the MA server 105 will notify the client 101 to continuously communicate with client 102 via the AAA mobile agent 100 using the same authentication information.

As shown in FIG. 4, the RTP session will continue uninterrupted via the AAA mobile agent 100. The AAA server 105 has the correct accounting information throughout the RTP session and will create only one accounting record for the RTP session.

The system and method for providing AAA functions in an IP based mobile communication system in accordance with the invention provides a AAA mobile agent that detects handoff procedures in an RTP session. The MA server is notified of each handoff procedure by the AAA mobile agent. The MA server is thus enabled to update session information to continue authorizing the session. Correct session duration enables correct accounting information.

It should be understood, of course, that the foregoing relates to preferred embodiments of the invention and that modifications may be made without departing from the spirit and scope of the invention as set forth in the following claims.

I claim:

1. A system for providing continuous AAA functionality in a mobile communication network comprising:
an RTP proxy coupled between clients in a session, the RTP proxy operable to (a) detect the handoff procedure and (b) notify a AAA server with updated client information.

2. The system of claim 1, wherein the updated client information comprises an updated client IP address.

3. A method for providing continuous AAA functionality in a mobile communication network comprising the steps of:
providing an RTP proxy coupled between clients in a session;
detecting a handoff procedure; and
notifying a AAA server with updated client information.

4. The method of claim 3, wherein the updated client information comprises an updated client IP address.
